(19) United States
(12) Patent Application Publication
(10) Pub. No.: US 2023/0418560 A1
(43) Pub. Date: Dec. 28, 2023

(54) Computation circuit used in DCT, DST, IDCT and IDST

(71) Applicant: REALTEK SEMICONDUCTOR CORPORATION, HSINCHU (TW)

(72) Inventors: SZU-CHUN CHANG, Hsinchu (TW); YI-CHEN TSENG, Hsinchu (TW)

(21) Appl. No.: 18/211,605

(22) Filed: Jun. 20, 2023

(30) Foreign Application Priority Data
Jun. 24, 2022 (TW) 111123777

(51) Int. Cl. G06F 7/523; G06F 7/501; G06F 5/01

(52) U.S. Cl. CPC G06F 7/523; G06F 7/501; G06F 5/01

(57) ABSTRACT

The present invention discloses a computation circuit. Each of a first and a second term computation circuits includes higher bit computation circuits, a lowest bit computation circuit and a first adder. Each of the higher bit computation circuits left-shifts a multiplier, outputs the effective shifted multiplier having a sign determined and further performs left-shifts without performing 2's complement computation to generate a higher bit computation result. The lowest bit computation circuit outputs the effective multiplier having the sign determined to generate a lowest bit computation result. The first adder adds the bit computation results to generate a term computation result. The third term computation circuit outputs an effective addend having the sign determined and adds the addend to the summation of a number of 2's complement to generate a third term computation result. The second adder adds the term computation results and the third term computation result to generate a total computation result.

### BACKGROUND OF THE INVENTION

### 1. Field of the Invention

The present invention relates to a computation circuit used in discrete cosine transform (DCT), discrete sine transform (DST), inverse discrete cosine transform (IDCT) and inverse discrete sine transform (IDST).

### 2. Description of Related Art

Along with the wide range of applications of multimedia technology on military and civil usages and the development of consumer electronics products, video coding/decoding becomes an important technology. Video coding/decoding is used to construct and playback videos, which is the basis of all the video technologies. The process of performing video coding/decoding requires the computation of DCT, DST, IDCT and IDST, and the circuits for performing these computations are complex.

As a result, a new design of computation circuit used to perform fast computation of DCT, DST, IDCT and IDST to decrease the delay of the circuit is in demand.

### SUMMARY OF THE INVENTION

In consideration of the problem of the prior art, an object of the present invention is to supply a comparator circuit having false-alarm preventing mechanism and an operation method of the same.

The present invention discloses a computation circuit used in DCT, DST, IDCT and IDST. The computation circuit includes a first term computation circuit, a second term computation circuit, a third term computation circuit, a 2's complement computation circuit and a second adder. Each of the first term computation circuit and a second term computation circuit includes a plurality of higher-bit computation circuits, a lowest bit computation circuit and a first adder. Each of the higher-bit computation circuits is configured to selectively perform left-shift of different numbers of bits on a multiplicand according to a shift control signal determined according to a multiplier to generate a shifted multiplicand, output the shifted multiplicand according to an effective level of a bit effective control signal determined according to the multiplier, determine a sign of the shifted multiplicand according to a bit sign control signal determined by the multiplier and perform left-shift of more number of bits on the shifted multiplicand when one of the higher-bit computation circuits corresponds to a higher bit without performing 2's complement computation thereon to generate a higher-bit computation result. The lowest bit computation circuit is configured to output the multiplicand according to the effective level of a lowest bit effective control signal determined according to the multiplier, and determine the sign of the multiplicand according to a lowest bit sign control signal determined by the multiplier to generate a lowest bit computation result. The first adder is configured to add the higher-bit computation result and the lowest bit computation result to generate a term computation result. The third term computation circuit is configured to output an addend according to the effective level of a term effective control signal, determine the sign of the added according to a term sign control signal and add the signed addend with a 2's complement sum to generate a third term computation result. The 2's complement computation circuit is configured to perform a predetermine logic operation on the bit sign control signal of each of bits of the first term computation circuit and the second term computation circuit and the lowest bit sign control signal to generate the 2's complement sum. The second adder is configured to add the term computation result of each of the first term computation circuit and the second term computation circuit and the third term computation result to generate a total computation result.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a circuit diagram of a block diagram of a computation circuit used in DCT, DST, IDCT and IDST according to an embodiment of the present invention.

FIG. 2A illustrates a more detailed block diagram of the first term computation circuit according to an embodiment of the present invention.

FIG. 2B illustrates a more detailed block diagram of the second term computation circuit according to an embodiment of the present invention.

FIG. 3 illustrates a more detailed block diagram of the 2's complement computation circuit according to an embodiment of the present invention.

### DETAILED DESCRIPTION OF THE PREFERRED EMBODIMENTS

An aspect of the present invention is to provide a computation circuit used in DCT, DST, IDCT and IDST to simplify the computation process such that the circuit is easy to be synthesized. Not only the delay brought by the 2's complement computation can be reduced, the routing complexity of the circuit can be reduced as well to obtain the low latency and small area at the same time. Further, the computation circuit is equipped with zero detection mechanism to avoid additional computation amount under the condition that the multiplicand is zero to further reduce the power consumption of the computation process.

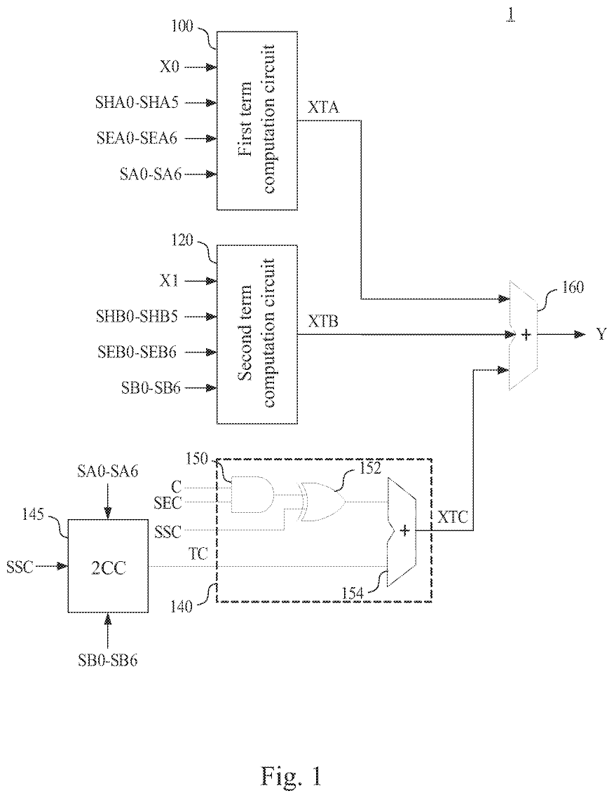

Reference is now made to FIG. 1. FIG. 1 illustrates a block diagram of a computation circuit 1 used in DCT, DST, IDCT and IDST according to an embodiment of the present invention. More specifically, the computation circuit 1 can be used to perform computation of DCT, DST, IDCT and IDST.

The computation circuit 1 includes a first term computation circuit 100, a second term computation circuit 120, a third term computation circuit 140, a 2's complement computation circuit 145 (abbreviated as 2CC in FIG. 1) and a second adder 160.

In an embodiment, video encoding/decoding process requires computation of DCT, DST, IDCT and IDST. During the computation, an equation of Y=±X00×A+X1×B±C is required to be computed. X0 is a multiplicand of the first term. A is a multiplier of the first term and is a constant. X1 is a multiplicand of the second term. B is a multiplier of the second term and is a constant. C is an input value from a previous stage to be added or subtracted.

As a result, the first term computation circuit 100, the second term computation circuit 120 and the third term computation circuit 140 respectively correspond to the computation of the first term (±X0×A), the second term (±X1×B) and the third term (C) of the equation described above.

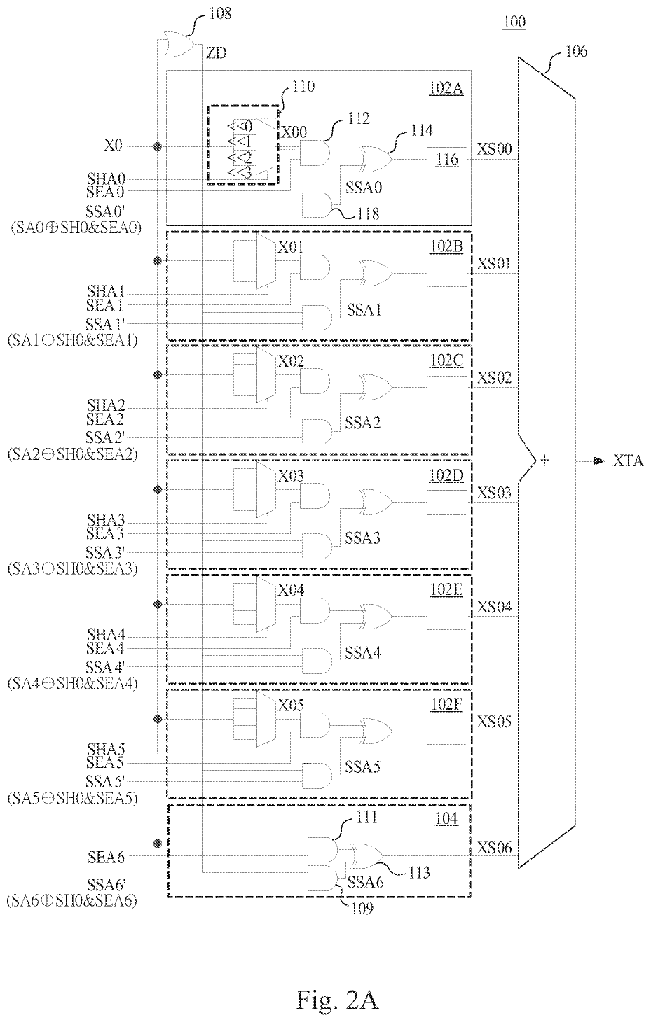

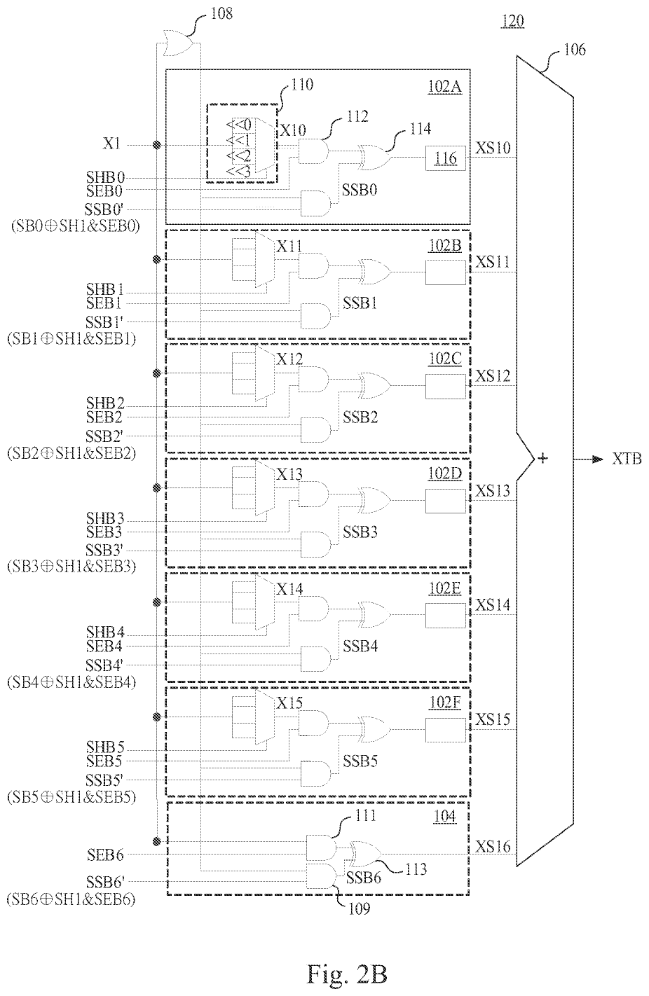

Reference is now made to FIG. 2A at the same time. FIG. 2A illustrates a more detailed block diagram of the first term computation circuit 100 according to an embodiment of the present invention. As described above, the first term computation circuit 100 is configured to compute the first term ±X0×A and includes higher-bit computation circuits 102A-102F, a lowest bit computation circuit 104 and a first adder 106.

In the present embodiment, the number of the higher-bit computation circuits 102A-102F is 6 and each of the higher-bit computation circuits 102A-102F has an identical configuration. Take the higher-bit computation circuit 102A as an example, the higher-bit computation circuit 102A includes a bit left-shift multiplexer 110, a bit output unit 112, a bit XOR gate 114 and a bit left-shift unit 116.

The bit left-shift multiplexer 110 is configured to selectively perform left-shift of different numbers of bits on the multiplicand X0 according to a shift control signal SHA0 determined according to the multiplier A to generate a shifted multiplicand X00.

In an embodiment, the bit left-shift multiplexer 110 selectively performs left-shift of 0, 1, 2 or 3 bits on the multiplicand X0 according to the shift control signal SHA0. As a result, the shift control signal SHA0 is actually a two-bit control signal. For example, the states of the shift control signal SHA0 can be 00, 01, 10 and 11 such that the bit left-shift multiplexer 110 performs left-shift of 0, 1, 2 and 3 bits respectively on the multiplicand X0 to output the shifted multiplicand X00.

The bit output unit 112 is configured to determine the output of the shifted multiplicand X00 according to the bit effective control signal SEA0 determined by the multiplier A. In an embodiment, the bit output unit 112 is implemented by an AND gate and the bit effective control signal SEA0 has an ineffective level and an effective level which is 0 and 1 respectively.

When the bit effective control signal SEA0 is at the ineffective level 0, the bit output unit 112 outputs the shifted multiplicand X00 to be a value of zero no matter what the original value of the shifted multiplicand X00 is. When the bit effective control signal SEA0 is at the effective level 1, the bit output unit 112 outputs the original value of the shifted multiplicand X00.

The bit XOR gate 114 is configured to determine a sign of the shifted multiplicand X00 according to a bit sign control signal SSA0. In an embodiment, the bit sign control signal SSA0 has a negative sign level and a positive sign level which is 1 and 0 respectively.

In an embodiment, the bit sign control signal SSA0 is generated by a bit sign control signal SSA0′ having an original value. The bit sign control signal SSA0′ is actually generated by performing XOR logic operation on a higher-bit sign signal SA0 and a term sign signal SH0 determined by the multiplier A to generate a first operation result and further performing AND logic operation on the first operation result and a bit effective control signal SEA0. The term sign signal SH0 is determined by the sign of the first term. When the first term has a positive sign, the term sign signal SH0 is 0. When the first term has a negative sign, the term sign signal SH0 is 1.

In an embodiment, each of the higher-bit computation circuits 102A-102F further includes a zero gated unit 118. Take the higher-bit computation circuit 102A as an example, the zero gated unit 118 is configured to keep the bit sign control signal SSA0 at an original value when a zero detection signal ZD is at a non-zero level such that the higher-bit computation circuit 102A performs computation accordingly, and set the bit sign control signal SSA0 to be zero when the zero detection signal ZD is at a zero level such that the higher-bit computation circuit 102A performs computation accordingly.

In an embodiment, the zero detection signal ZD is generated by performing OR logic operation on the multiplicand X0 and the multiplicand X0 itself. More specifically, the first term computation circuit 100 may further include an OR gate 108 to receive the multiplicand X0 at both of input terminals thereof to generate the zero detection signal ZD. When the multiplicand X0 is a non-zero value, the zero detection signal ZD is also a non-zero value so as to be at the non-zero level. When the multiplicand X0 is zero, the zero detection signal ZD is also zero so as to be at the zero level.

When the bit sign control signal SSA0 is at the negative sign level 1, the bit XOR gate 114 performs XOR logic operation on the shifted multiplicand X00 to output the shifted multiplicand X00 having the negative sign. When the bit sign control signal SSA0 is at the positive sign level 0, the bit XOR gate 114 performs XOR logic operation on the shifted multiplicand X00 to output the shifted multiplicand X00 having the positive sign. The bit sign control signal SSA0 is further used by the 2's complement computation circuit 145 to compute a 2's complement.

Under some conditions, though the multiplicand X0 is zero, a negative sign is applied such that a computation of 2's complement is required to induce a large amount of necessary computation when the same computation result is generated. As a result, the zero gated unit 118 forces the bit sign control signal SSA0 to be zero under the condition that the multiplicand X0 is zero such that the positive sign is assigned to the multiplicand X0 to greatly reduce the unnecessary computation amount of the bit XOR gate 114.

On the contrary, when the multiplicand X0 is not zero, the zero gated 118 outputs the original sign of the multiplicand X0, which is the bit sign control signal SSA0 that is one of the positive sign level 0 and the negative sign level 1.

The bit left-shift unit 116 is configured to perform left-shift of more number of bits on the shifted multiplicand X00 when the higher-bit computation circuit 102A corresponds to a higher bit without performing 2's complement computation thereon to generate a higher-bit computation result XS00. In an embodiment, the higher-bit computation circuit 102A corresponds to a highest bit so as to perform left-shift of 11 bits on the shifted multiplicand X00.

Identically, the bit left-shift multiplexer 110 of each of the higher-bit computation circuits 102B-102F selectively performs left-shift of 0, 1, 2 or 3 bits on the multiplicand X0 according to the shift control signals SHA1-SHA5 respectively to generate the shifted multiplicands X01-X05. The bit output unit 112 of each of the higher-bit computation circuits 102B-102F determines whether the shifted multiplicands X01-X05 are outputted effectively according to the bit effective control signals SEA1-SEA5 respectively.

The bit XOR gate 114 of each of the higher-bit computation circuits 102B-102F determines the signs of the shifted multiplicand X01-X05 according to the bit sign control signals SSA1-SSA5 respectively. The zero gated unit 118 of each of the higher-bit computation circuits 102B-102F determines whether the multiplicands X01-X05 are zero to further determine whether the bit sign control signal SSA0 is outputted based on the original value or is set to be zero.

The bit left-shift unit 116 of each of the higher-bit computation circuits 102B-102F performs left-shift of more number of bits, e.g., 9, 7, 5, 3 and 1 bits respectively, on the shifted multiplicands X01-X05 when the higher-bit computation circuits 102B-102F correspond to a higher bit without performing 2's complement computation thereon to generate higher-bit computation results XS01-XS05.

The lowest bit computation circuit 104 includes a lowest bit output unit 111 and a lowest bit XOR gate 113.

The lowest bit output unit 111 is configured to determine the output of the multiplicand X0 according to a lowest bit effective control signal SEA6 determined by the multiplier A. In an embodiment, the lowest bit output unit 111 is implemented by an AND gate and the lowest bit effective control signal SEA6 has an ineffective level and an effective level that is 0 and 1 respectively.

When the lowest bit effective control signal SEA6 is at the ineffective level 0, the lowest bit output unit 111 outputs the multiplicand X0 to be a value of zero no matter what the original value of the multiplicand X0 is. When the lowest bit effective control signal SEA6 is at the effective level 1, the lowest bit output unit 111 outputs the original value of the multiplicand X0.

The lowest bit XOR gate 113 is configured to determine a sign of the multiplicand X0 according to the lowest bit sign control signal SSA6. In an embodiment, the lowest bit sign control signal SSA6 has a positive sign level and a negative sign level which is 0 and 1 respectively.

In an embodiment, the lowest bit sign control signal SSA6 is generated by performing AND logic operation on a lowest bit sign signal SA6 and the term sign signal SH0 determined by the multiplier A.

As a result, when the lowest bit sign control signal SSA6 has the negative sign level 1, the lowest bit XOR gate 113 performs XOR logic operation on the multiplicand X0 to output the multiplicand X0 having the negative sign. When the lowest bit sign control signal SSA6 has the positive sign level 0, the lowest bit XOR gate 113 performs XOR logic operation on the multiplicand X0 to output the multiplicand X0 having the positive sign. The lowest bit sign control signal SSA6 is further used by the 2's complement computation circuit 145 to compute a 2's complement. The multiplicand X0 having the sign outputted by the lowest bit XOR gate 113 serves as the lowest bit computation result XS06.

In an embodiment, the lowest bit computation circuit 104 includes a lowest bit zero gated unit 109 configured to keep the lowest bit sign control signal SSA6 at an original value when the zero detection signal ZD is at the non-zero level, and set the lowest bit sign control signal SSA6 to be zero when the zero detection signal ZD is at zero level.

The first adder 106 is configured to add the higher-bit computation results XS01-XS05 and the lowest bit computation result XS06 to generate a term computation result XTA.

In an embodiment, the shift control signal SHA0-SHA5, the bit effective control signal SEA0-SEA5, the higher-bit sign signal SA0-SA5, the lowest bit effective control signal SEA6 and the lowest bit sign signal SA6 are determined by looking up a multiplier look-up table according to the multiplier A.

Reference is now made to Table 1. Table 1 is a content of the multiplier look-up table according to an embodiment of the present invention.

TABLE 1

| multiplier A | SEA0-SEA6 | SA0-SA6 | SHA0-SHA5 |
|---|---|---|---|
| 0 | 0000000 | 0000000 | 000000000000 |
| 2 | 0000010 | 0000000 | 000000000000 |
| 4 | 0000010 | 0000000 | 000000000001 |
| 64 | 0000100 | 0000000 | 000000001100 |
| 87 | 0001111 | 0000001 | 000000010110 |
| 75 | 0001111 | 0000000 | 000000010000 |
| 83 | 0001111 | 0000001 | 000000010101 |
| 18 | 0000110 | 0000000 | 000000000100 |
| −83 | 0001111 | 0001110 | 000000010101 |
| 36 | 0000110 | 0000000 | 000000001001 |
| 90 | 0011110 | 0001100 | 000000000000 |

In an embodiment, the multiplier look-up table illustrated in Table 1 can be used in video encoding/decoding standards of HEVC/AVS2/VVC/AVS3. It is appreciated that Table 1 only exemplarily lists parts of the values. In practical application, the multiplier look-up table may include more corresponding values. The present invention is not limited thereto.

The first column in the table includes the values of multiplier A, e.g., the first column and the seventh row corresponds to the multiplier A of the value 83. The second column in the table includes the content of the bit effective control signals SEA0-SEA5 and the lowest bit effective control signal SEA6. The bit values in each of the entries, e.g., 0001111 of the entry at the second column and the fifth row, in turn correspond to the signals from the highest bit to the lowest bit.

The third column in the table includes the content of the higher-bit sign signals SA0-SA5 and the lowest bit sign signal SA6. The bit values in each of the entries, e.g., 0000001 of the entry at the third column and the fifth row, in turn correspond to the signals from the highest bit to the lowest bit. The fourth column in the table includes the content of the shift control signals SHA0-SHA5. Every two bit values in each of the entries, e.g., 000000010110 of the entry at the fourth column and the fifth row, in turn correspond to the signals from the highest bit to the lowest bit.

As a result, for the example of the multiplier A having the value of 83 and X0 is 1 (which is 0x0001 in hexadecimal), the bit left-shift multiplexer 110 included by each of the higher-bit computation circuits 102A-102F performs left-shift of 0, 0, 0, 1, 1 and 1 bit respectively on X0 according to the values (000000010101) of the shift control signals SHA0-SHA5 generated by looking up Table 1. The shifted multiplicands X00-X05 having the values of 0x0001, 0x0001, 0x0001, 0x0002, and 0x0002 are thus generated.

Subsequently, the bit output unit 112 included by each of the higher-bit computation circuits 102A-102F and the lowest bit output unit 111 included by the lowest bit computation circuit 104 determine that the shifted multiplicand X00-X02 are ineffective to be outputted as 0 and determines that the shifted multiplicand X03-X06 are effective according to the values (0001111) of the bit effective control signal SEA0-SEA5 and the lowest bit effective control signal SEA6 generated by looking up Table 1. As a result, the bit output unit 112 included by each of the higher-bit computation circuits 102A-102F and the lowest bit output unit 111 included by the lowest bit computation circuit 104 output 0x0000, 0x0000, 0x0000, 0x0002, 0x0002 and 0x0001.

Since the multiplicand X0 is not 0, the zero gated unit 118 keeps the bit sign control signals SSA0-SSA5 at the original values according to the zero detection signal ZD at the non-zero level such that the higher-bit computation circuits 102A-102F operate accordingly.

The bit XOR gate 114 included in each of the higher-bit computation circuits 102A-102F and the lowest bit XOR gate 113 included in the lowest bit computation circuit 104 determine the sign of each of the shifted multiplicand X00-X05 and the multiplicand X0 according to the bit sign control signals SSA0-SSA5 and the lowest bit sign control signal SSA6 generated by looking up Table 1. More specifically, the values of the bit sign control signal SSA0-SSA5 and the lowest bit sign control signal SSA6 are generated by performing XOR logic operation on the term sign signal SH0 and the values (0000001) of the higher-bit sign signals SA0-SA5 and lowest bit sign signal SA6 generated by looking up Table 1.

In the present embodiment, the first term having the positive sign sets the term sign signal SH0 to be 0. As a result, the values of the bit sign control signal SSA0-SSA5 and the lowest bit sign control signal SSA6 are (0000001). The bit XOR gate 114 included by each of the higher-bit computation circuits 102A-102F respectively outputs the shifted multiplicands X00-X05 each having a sign, which are 0x0000, 0x0000, 0x0002, 0x0002 [symbol] 0x0002. The lowest bit XOR gate 113 included by the lowest bit computation circuit 104 outputs the multiplicand X0 having a sign, to generate the lowest bit computation result XS06 of 0xFFFE.

Subsequently, the bit left-shift unit 116 included by each of the higher-bit computation circuits 102A-102F performs left-shift of 11, 9, 7, 5, 3 and 1 bits respectively on the shifted multiplicands X00-X05 each having the sign to generate the higher-bit computation results XS00-XS05. Since the shifted multiplicands X00-X02 are 0, the higher-bit computation results XS00-X502 generated according to the left-shift of bits are still 0. The shifted multiplicands X03-X05, which are 0x0002, and 0x0002, are left-shifted by 5, 3 and 1 bits to generate the higher-bit computation results X503-XSOS that are 0x0040, 0x0010 and 0x0004 respectively.

The first adder 106 adds the higher-bit computation results XS00-XS05 and the lowest bit computation result X506 to generate the term computation result XTA, which is equivalent to ±X0×A. As a result, the term computation result XTA generated accordingly is 0x0040+0x0010+0x0004+0xFFFE=0x0052.

As a result, the first term computation circuit 100 can compute the first term ±X0×A based on the process described above.

Reference is now made to FIG. 2B. FIG. 2B illustrates a more detailed block diagram of the second term computation circuit 120 according to an embodiment of the present invention.

The second term computation circuit 120 may include the configuration same as that of the first term computation circuit 100. More specifically, the second term computation circuit 120 may include the higher-bit computation circuits 102A-102F, the lowest bit computation circuit 104 and the first adder 106. Since the configuration and the computation process of the second term computation circuit 120 are identical to those of the first term computation circuit 100, the detail related to the second term computation circuit 120 is not described herein.

When the multiplier B is −83, the related data are looked up from Table 1 according to the value of −83. When the multiplicand X1 is 1 (which is 0x0001 in hexadecimal), the bit left-shift multiplexer 110 included by each of the higher-bit computation circuits 102A-102F generates the shifted multiplicands X10-X15 having the values of 0x0000, 0x0000, 0x0000, 0x0002, 0x0002 and 0x0002 according to the shift control signal SHB0-SHB5 generated by looking up Table 1. The bit output unit 112 included by each of the higher-bit computation circuits 102A-102F and the lowest bit output unit 111 included by the lowest bit computation circuit 104 output 0x0000, 0x0000, 0x0002, 0x0002, 0x0002 and 0x0001.

Since the multiplicand X1 is not 0, the zero gated unit 118 keeps the bit sign control signals SSB0-SSB5 to be the original values according to the zero detection signal ZD at the non-zero level such that the higher-bit computation circuits 102A-102F operates accordingly. The bit XOR gate 114 included by each of the higher-bit computation circuits 102A-102F and the lowest bit XOR gate 113 included by the lowest bit computation circuit 104 determine the signs of the shifted multiplicands X10-X15 and the multiplicand X1 according to the values of the bit sign control signal SSB0-SSB5 and the lowest bit sign control signal SSB6 generated by looking up Table 1. More specifically, the values of the bit sign control signal SSB0-SSB5 and the lowest bit sign control signal SSB6 are generated by performing XOR logic operation on the term sign signal SH1 and the values (0001110) of the higher-bit sign signals SB0-SB5 and lowest bit sign signal SB6 generated by looking up Table 1.

In the present embodiment, the second term having the negative sign sets term sign signal SH1 to be 0. The values of the bit sign control signals SSB0-SSB5 and lowest bit sign control signal SSB6 are (0001110). The bit XOR gate 114 included by each of the higher-bit computation circuits 102A-102F respectively outputs the shifted multiplicands X10-X15 each having a sign, which are 0x0000, 0x0000, 0xFFFD, 0xFFFD and 0xFFFD. The lowest bit XOR gate 113 included by the lowest bit computation circuit 104 outputs the multiplicand X1 having a sign, to generate the lowest bit computation result XS16 of 0x0001.

Subsequently, the bit left-shift unit 116 included by each of the higher-bit computation circuits 102A-102F performs left-shift of 11, 9, 7, 5, 3 and 1 bits respectively on the shifted multiplicands X10-X15 each having the sign to generate the higher-bit computation results XS10-XS15, which are 0x0000, 0x0000, 0x0000, 0xFFAO, 0xFFE8 and 0xFFFA.

The first adder 106 adds the higher-bit computation results XS10-XS15 and the lowest bit computation result XS16 to generate the term computation result XTB, which is equivalent to ±X1×B. As a result, the term computation result XTB is x0000+0xFFAO+0xFFE8+0xFFFA+0x0001=0 xFF83=−125.

The third term computation circuit 140 includes a term output unit 150, a term XOR gate 152 and a third adder 154.

The term output unit 150 is configured to determine whether the addend C is outputted effectively according to the term effective control signal SEC. When the term effective control signal SEC is at an ineffective level 0, the term output unit 150 outputs the addend C to be a value of zero no matter what the original value of addend C is. When the term effective control signal SEC is at an effective level 1, the term output unit 150 outputs the original value of the addend C.

The term XOR gate 152 determines a sign of the addend C according to the term sign control signal SSC. In the present embodiment, the third term having a positive sign sets the term sign control signal SSC to be 0. The term XOR gate 152 performs XOR logic operation on the addend C and the term sign control signal SSC to generate the addend C having a positive sign. The third term having a negative sign sets the term sign control signal SSC to be 1. The term XOR gate 152 performs XOR logic operation on the addend C and the term sign control signal SSC to generate the addend C having a negative sign.

In an embodiment, the addend C is 0 and the term sign control signal SSC is 0.

The third adder 154 is configured to add the addend C having the sign and the 2's complement sum TC to generate the third term computation result XTC.

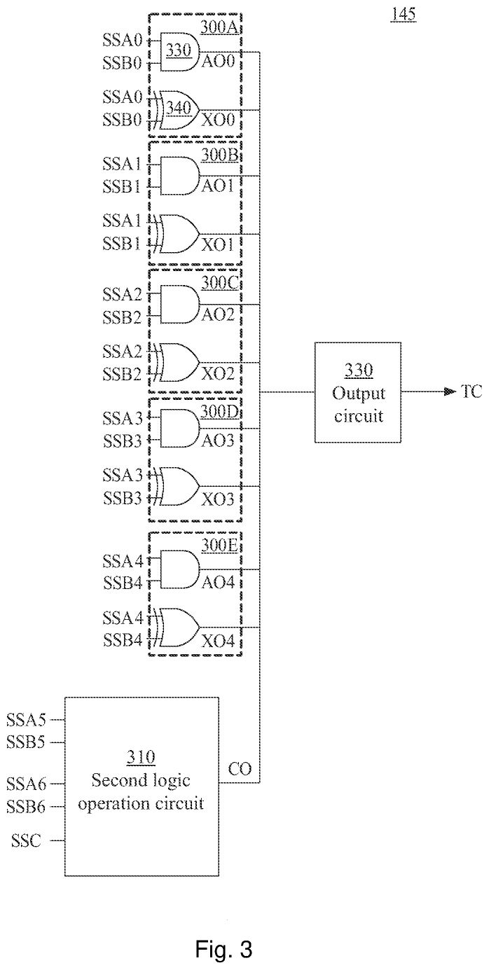

Reference is now made to FIG. 3. FIG. 3 illustrates a more detailed block diagram of the 2's complement computation circuit 145 according to an embodiment of the present invention. The 2's complement computation circuit 145 includes a plurality of a first logic operation circuits 300A-300E, a second logic operation circuit 310 and an output circuit 330.

In an embodiment, when the number of the higher-bit computation circuits is N, the number of the first logic operation circuits is N−1 to correspond to the N−1 higher-bit computation circuits having the highest bits. Take the embodiment in FIG. 2 as an example, the number of the higher-bit computation circuits 102A-102F is 6. As a result, the number of the first logic operation circuits 300A-300E is 5 to correspond to the higher-bit computation circuits 102A-102E of 5 highest bits to perform computation accordingly.

Take the first logic operation circuit 300A, the first logic operation circuit 300A includes a complement AND gate 330 and a complement XOR gate 340. The complement AND gate 330 is configured to perform computation on a pair of the bit sign control signals SSA0 and SSB0 corresponding to one of the higher-bit computation circuits (e.g., the higher-bit computation circuit 102A) of the first term computation circuit 100 and one of the higher-bit computation circuits (e.g., the higher-bit computation circuit 102A) of the second term computation circuit 120 to generate an AND gate output signal AO0. The complement XOR gate 340 is configured to perform computation on the pair of the bit sign control signals SSA0 and SSB0 corresponding to one of the higher-bit computation circuits (e.g., the higher-bit computation circuit 102A) of the first term computation circuit 100 and one of the higher-bit computation circuits (e.g., the higher-bit computation circuit 102A) of the second term computation circuit 120 to generate a XOR gate output signal xO0.

Similarly, the first logic operation circuits 300B-300E perform logic operation on the bit sign control signals SSA1˜SSA4 and SSB1˜SSB4 corresponding to the higher-bit computation circuits 102B-102E to respectively generate AND gate output signals AO1˜AO4 and XOR gate output signals XO1˜XO4.

In the example described above, since the bit sign control signals SSA0˜SSA4 are all 0 and the bit sign control signals SSB0˜SSB4 are 00011, the AND gate output signals AO1˜AO4 are all 0 and the XOR gate output signals XO1˜XO4 are 00011.

The second logic operation circuit 310 is configured to perform computation on one of the higher-bit computation circuits having the lowest bit, which is the higher-bit computation circuit 102F, of the first term computation circuit 100 and the second term computation circuit 120 and the lowest bit computation circuit 104, to select one of a plurality of predetermined logic operation formulas according to the term sign control signal SSC and the lowest bit sign control signals SSA6 and SSB6 to perform logic operation on the bit sign control signals SSA5 and SSB5 to generate a complement output signal CO.

In an embodiment, the predetermined logic operation formulas are illustrated in Table 2:

TABLE 2

| SSC, SSA6 and SSB6 | CO |
|---|---|
| 000 | SSA5&SSB5, SSA5\hat{ }SSB5, 0 |
| 001 | SSA5&SSB5, SSA5\hat{ }SSB5, 1 |
| 010 | SSA5&SSB5, SSA5\hat{ }SSB5, 1 |
| 011 | SSA5\|SSB5, ~(SSA5\hat{ }SSB5), 0 |
| 100 | SSA5&SSB5, SSA5\hat{ }SSB5, 1 |
| 101 | SSA5\|SSB5, ~(SSA5\hat{ }SSB5), 0 |
| 110 | SSA5\|SSB5, ~(SSA5\hat{ }SSB5), 0 |
| 111 | SSA5\|SSB5, ~(SSA5\hat{ }SSB5), 1 |

The symbol ‘&’ stands for AND logic operation. The symbol ‘A’ stands for XOR logic operation. The symbol T stands for OR logic operation. The symbol ‘˜’ stands for NOT logic operation.

In the embodiment described above, the term sign control signal SSC is 0 and the lowest bit sign control signals SSA6 and SSB6 are 1 and 0 respectively. As a result, the logic operation formula “SSA5&SSB5, SSA5\hat{ }SSB5, 1” in Table 2 is selected to perform computation to generate the complement output signal CO having three bits and the values of (0, 1, 1).

The output circuit 330 is configured to add the AND gate output signals AO0˜AO4 and the XOR gate output signals XO0˜XO4 of the first logic operation circuits 300A-300E to generate an added result having the value of 2′b0101000 and further add the added result and the complement output signal CO, which is (0, 1, 1), to generate the 2's complement TC having the value of 0x2b=43. The third adder 154 is configured to add the addend C having the sign and the 2's complement sum TC to generate the third term computation result XTC. For equation of Y=+83×1−83×1+0, SCC0=0, and XTC=43.

The second adder 160 is configured to add the term computation results XTA and XTB of each of the first term computation circuit 100 and the second term computation circuit 120 and the third term computation result XTC to generate a total computation result Y. It is appreciated that in FIG. 1, the second adder 160 is illustrated as a single adder. However, in practical implementation, the second adder 160 can be implemented by two adders, in which one adder adds the term computation results XTA and XTB, and the other adder adds the added result generated by the previous adder and the third term computation result XTC to generate the total computation result Y. The present invention is not limited thereto. In the example of Y=±X0×A±X1×B±C=+1×83−1×83+0=0, XTA=0x0052, XTB=0xFF83 and XTC=0x2b. As a result, Y=XTA+XTB+XTC=0x0052+0xFF83+0x2b=0x0000.

It is appreciated that the multiplier look-up table used in video encoding/decoding standards of HEVC/AVS2/VVC/AVS3 is used as an example in the embodiment described above. In other embodiments, the computation circuit 1 can also use the multiplier look-up table used in video encoding/decoding standards of such as, but not limited to VP9 and AV1.

It is appreciated that the embodiments described above are merely an example. In other embodiments, it should be appreciated that many modifications and changes may be made by those of ordinary skill in the art without departing, from the spirit of the disclosure.

In summary, the present invention discloses the computation circuit used in DCT, DST, IDCT and IDST simplifies the computation process such that the circuit is easy to be synthesized. Not only the delay brought by the 2's complement computation can be reduced, the routing complexity of the circuit can be reduced as well to obtain the low latency and small area at the same time. Further, the computation circuit is equipped with zero detection mechanism to avoid additional computation amount under the condition that the multiplicand is zero to further reduce the power consumption of the computation process.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A computation circuit for discrete transformation comprising:
a first term computation circuit and a second term computation circuit each comprising:
a plurality of higher-bit computation circuits each configured to:
selectively perform left-shift of different numbers of bits on a multiplicand according to a shift control signal determined according to a multiplier to generate a shifted multiplicand;
output the shifted multiplicand according to an effective level of a bit effective control signal determined according to the multiplier;
determine a sign of the shifted multiplicand according to a bit sign control signal determined by the multiplier; and
perform left-shift of more number of bits on the shifted multiplicand when one of the higher-bit computation circuits corresponds to a higher bit without performing 2's complement computation thereon to generate a higher-bit computation result;
a lowest bit computation circuit configured to output the multiplicand according to the effective level of a lowest bit effective control signal determined according to the multiplier, and determine the sign of the multiplicand according to a lowest bit sign control signal determined by the multiplier to generate a lowest bit computation result; and
a first adder configured to add the higher-bit computation result and the lowest bit computation result to generate a term computation result;
a third term computation circuit configured to output an addend according to the effective level of a term effective control signal, determine the sign of the added according to a term sign control signal and add the signed addend with a 2's complement sum to generate a third term computation result;
a 2's complement computation circuit configured to perform a predetermine logic operation on the bit sign control signal of each of bits of the first term computation circuit and the second term computation circuit and the lowest bit sign control signal to generate the 2's complement sum; and
a second adder configured to add the term computation result of each of the first term computation circuit and the second term computation circuit and the third term computation result to generate a total computation result.

2. The computation circuit of claim 1, wherein each of the higher-bit computation circuits includes:
a bit left-shift multiplexer configured to selectively perform left-shift of the different numbers of bits on the multiplicand according to the shift control signal to generate the shifted multiplicand;
a bit output unit configured to output an original value of the shifted multiplicand when the bit effective control signal is at the effective level and output the shifted multiplicand to be a value of zero when the bit effective control signal is at an ineffective level;
a bit XOR gate configured to output the shifted multiplicand with a positive sign when the bit sign control signal is at a positive sign level and output the shifted multiplicand with a negative sign when the bit sign control signal is at a negative sign level; and
a bit left-shift unit configured to perform left-shift of more number of bits on the shifted multiplicand when one of the higher-bit computation circuits corresponds to a higher bit without performing 2's complement computation thereon to generate the higher-bit computation result.

3. The computation circuit of claim 2, wherein a number of the higher-bit computation circuits is 6 and the bit left-shift unit of each of the higher-bit computation circuits respectively performs left-shift of 11, 9, 7, 5, 3 and 1 bits, and the bit left-shift multiplexer selectively performs left-shift of 0, 1, 2 or 3 bits on the multiplicand according to the shift control signal to generate the shifted multiplicand.

4. The computation circuit of claim 2, wherein the lowest bit computation circuit comprises:
a lowest bit output unit configured to output the multiplicand when the lowest bit effective control signal is at the effective level and output the multiplicand to be a value of zero when the lowest bit effective control signal is at the ineffective level; and
a lowest bit XOR gate configured to output the multiplicand with a positive sign when the lowest bit sign control signal is at the positive sign level and output the multiplicand with a negative sign when the lowest bit sign control signal is at the negative sign level to generate the lowest bit computation result.

5. The computation circuit of claim 1, wherein the third term computation circuit further comprises:
a term output unit configured to output an original value of the addend when the term effective control signal is at the effective level and output the addend to be a value of zero when the term effective control signal is at an ineffective level;
a term XOR gate configured to output the addend with a positive sign when the term sign control signal is at a positive sign level and output the addend with a negative sign when the term sign control signal is at a negative sign level; and
a third adder configured to add the addend and the 2's complement sum to generate the third term computation result.

6. The computation circuit of claim 1, wherein the shift control signal, the bit effective control signal, the bit sign control signal, the lowest bit effective control signal and the lowest bit sign control signal is determined by looking up a multiplier look-up table according to the multiplier.

7. The computation circuit of claim 6, wherein the multiplier look-up table corresponds to one of standards of HEVC, AVS2, VP9, AV1, VVC and AVS3 or any other video standards.

8. The computation circuit of claim 1, wherein a number of the higher-bit computation circuits is N and the 2's complement computation circuit comprises:
a plurality of first logic operation circuits configured to perform computation on the higher-bit computation circuits corresponding to N−1 highest bits of the first term computation circuit and the second term computation circuit, each of the first logic operation circuits comprising:
a complement AND gate configured to perform computation on a pair of the bit sign control signals corresponding to one of the higher-bit computation circuits of the first term computation circuit and one of the higher-bit computation circuits of the second term computation circuit to generate an AND gate output signal; and
a complement XOR gate configured to perform computation on the pair of the bit sign control signals corresponding to one of the higher-bit computation circuits of the first term computation circuit and one of the higher-bit computation circuits of the second term computation circuit to generate a XOR gate output signal;
a second logic operation circuit configured to perform computation on one of the higher-bit computation circuits having the lowest bit of the first term computation circuit and the second term computation circuit and the lowest bit computation circuit, to select one of a plurality of predetermined logic operation formulas according to the term sign control signal and the lowest bit sign control signal to perform logic operation on the bit sign control signal to generate a complement output signal; and
an output circuit configured to add the AND gate output signal and the XOR gate output signal of the first logic operation circuits to generate an added result and further add the added result and the complement output signal to generate the 2's complement.

9. The computation circuit of claim 1, wherein the bit sign control signal is generated by performing XOR logic operation on a higher-bit sign signal and a term sign signal determined by the multiplier, and the lowest bit sign control signal is generated by performing XOR logic operation on a lowest bit sign signal and the term sign signal.

10. The computation circuit of claim 9, wherein each of the higher-bit computation circuits further comprises a zero gated unit configured to keep the bit sign control signal at an original value when a zero detection signal is at a non-zero level such that the higher-bit computation circuits perform computation accordingly, and set the bit sign control signal to be zero when the zero detection signal is at a zero level such that the higher-bit computation circuits perform computation accordingly; and
the lowest bit computation circuit comprises a lowest bit zero gated unit configured to keep the lowest bit sign control signal at an original value when the zero detection signal is at the non-zero level such that the lowest bit computation circuit perform computation accordingly, and set the lowest bit sign control signal to be zero when the zero detection signal is at the zero level such that the lowest bit computation circuit perform computation accordingly;
wherein the zero detection signal is generated by performing OR logic operation on the multiplicand and the multiplicand itself.
